(19) United States
(12) Patent Application Publication
(10) Pub. No.: US 2023/0146156 A1
(43) Pub. Date: May 11, 2023

(54) MAP PROCESSING SYSTEM AND NON-TRANSITORY COMPUTER-READABLE STORAGE MEDIUM HAVING MAP PROCESSING PROGRAM STORED THEREON

(71) Applicant: DENSO CORPORATION, Kariya City (JP)

(72) Inventor: Kiyoshi TSURUMI, Kariya City (JP)

(21) Appl. No.: 18/151,000

(22) Filed: Jan. 6, 2023

Related U.S. Application Data
(63) Continuation of application No. PCT/JP21/22688, filed on Jun. 15, 2021.

(30) Foreign Application Priority Data
Jul. 10, 2020 (JP) 2020-119193

(51) Int. Cl. G01C 21/32; G01C 21/00

(52) U.S. Cl. CPC G01C 21/32; G01C 21/3815; G01C 21/3867; G01C 21/3841

(57) ABSTRACT

A map processing system includes a skeleton generating section configured to generate a skeleton that represents a road geometry based on a first map, a divided section data generating section configured to generate divided section data by dividing the skeleton at a division point, an offset value calculating section configured to calculate an offset value between the first map and a second map per section corresponding to the divided section data, and a map processing section configured to process the first map using the offset value.

### CROSS-REFERENCE TO RELATED APPLICATION

The present application is a continuation application of International Application No. PCT/JP2021/022688, filed on Jun. 15, 2021, which claims priority to Japanese Patent Application No. 2020-119193, filed in Japan on Jul. 10, 2020. The contents of these applications are incorporated herein by reference in their entirety.

### BACKGROUND

### 1. Technical Field

The present disclosure relates to a map processing system.

### 2. Related Art

Map processing devices have been provided that acquire probe data from a vehicle side, generate an input map based on the acquired probe data, and generate an integrated input map by integrating multiple input maps or update a reference map by correcting the position of the input map. Specifically, such a map processing device generates, for example, multiple input maps including positional information of feature points such as landmarks, matches the feature points included in the generated input maps, and superimposes the input maps to generate an integrated input map. Alternatively, the position of the input map is corrected by superimposing the reference map on the input map while matching the feature points included in the reference map with the feature points included in the input map, and the difference between the reference map and the input map is reflected in the reference map to update the reference map.

### SUMMARY

The present disclosure provides a map processing system for appropriately processing a map. As one aspect of the present disclosure, a map processing system includes at least a skeleton generating section, a divided section data generating section, an offset value calculating section, and a map processing section. The skeleton generating section is configured to generate a skeleton that represents a road geometry based on a first map. When a skeleton is extracted, the divided section data generating section is configured to generate divided section data by dividing the extracted skeleton at a division point. When a divided section data is generated, the offset value calculating section is configured to calculate an offset value between the first map and a second map per section corresponding to the divided section data that has been generated. When the offset value is calculated, the map processing section is configured to process the first map using the calculated offset value.

### BRIEF DESCRIPTION OF THE DRAWINGS

In the accompanying drawings:

FIG. 1 is a functional block diagram illustrating the general arrangement of a map updating system according to one embodiment;

FIG. 2 is a functional block diagram illustrating a control section of a server;

FIG. 3 is a first diagram illustrating how a skeleton is generated;

FIG. 4 is a second diagram illustrating how a skeleton is generated;

FIG. 5 is a third diagram illustrating how a skeleton is generated;

FIG. 6 is a first diagram illustrating how divided section data is generated;

FIG. 7 is a second diagram illustrating how divided section data is generated;

FIG. 8 is a diagram illustrating how the position of an input map is corrected;

FIG. 9 is a diagram illustrating a state in which a phase shift differs;

FIG. 10 is a diagram illustrating how the position of an input map is corrected; and

FIG. 11 is a flowchart illustrating processes performed by a microcomputer.

### DETAILED DESCRIPTION OF THE PREFERRED EMBODIMENTS

Map processing devices have been provided that acquire probe data from a vehicle side, generate an input map based on the acquired probe data, and generate an integrated input map by integrating multiple input maps or update a reference map by correcting the position of the input map.

In generating the integrated input map or updating the reference map as described above, measurement errors between maps need to be eliminated. A configuration for correcting a map is disclosed in, for example, JP 2004-177862 A. The configuration includes setting three or more correction reference points and performing affine transformation so that the three or more correction reference points that have been set coincide with the corresponding reference points on the reference map. Alternatively, for example, JP 2019-179217 A discloses a configuration in which grid points are set on the map, and the map is corrected using offset values of the grid points that have been set.

Both the configurations disclosed in JP 2004-177862 A and JP 2019-179217 A mentioned above perform batch correction on a map-by-map basis. The displacement between the maps occurs differently in different parts instead of uniformly over a wide area due to the properties of the probe data including the positioning result obtained by a GPS receiver. When the displacement between the maps occurs differently in different parts, the displacement between the maps is only partially eliminated, and the maps are not appropriately processed.

It is an object of the present disclosure to appropriately eliminate the displacement between maps over a wide area and to appropriately process the maps.

According to an aspect of the present disclosure, a skeleton generating section is configured to generate a skeleton that represents a road geometry based on a first map. When a skeleton is extracted, a divided section data generating section is configured to generate divided section data by dividing the extracted skeleton at a division point. When a divided section data is generated, an offset value calculating section is configured to calculate an offset value between the first map and a second map per section corresponding to the divided section data that has been generated. When the offset value is calculated, a map processing section is configured to process the first map using the calculated offset value.

The skeleton representing the road geometry is generated based on the first map. The divided section data is generated by dividing the generated skeleton at the division point. The offset value between the first map and the second map is calculated per section corresponding to the divided section data that has been generated. When the offset value is calculated, the map is processed based on the calculated offset value. The offset value is calculated per section corresponding to the divided section data, and the correction is made per section. Thus, the displacement between the maps is appropriately eliminated over a wide area, and the map is appropriately processed.

The above-mentioned and other objects, features, and advantages of the present disclosure will become more apparent by reference to the following description taken in conjunction with the accompanying drawings.

An embodiment will now be described with reference to the drawings. The present embodiment describes a case in which the position of an input map is corrected by superimposing a reference map on the input map while matching feature points included in the reference map with the feature points included in the input map, and the difference between the reference map and the input map is reflected in the reference map to update the reference map. The present embodiment may also be applied to a case in which an integrated input map is generated by superimposing multiple input maps while matching feature points included in the input maps. In other words, maps the feature points of which are to be matched may include the reference map and the input map or multiple input maps.

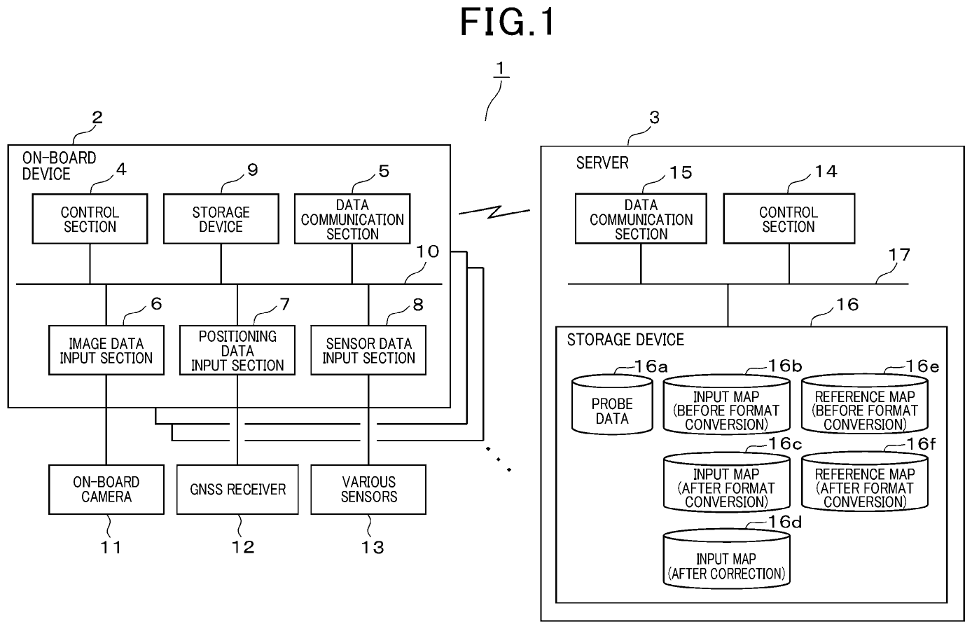

As shown in FIG. 1, the map processing system 1 includes an on-board device 2, which is mounted on a vehicle side, and a server 3, which is located on a network side. The on-board device 2 and the server 3 can communicate data with each other. The on-board device 2 and the server 3 have a multiple-to-one relationship, and the server 3 can communicate data with multiple on-board devices 2.

The on-board device 2 includes a control section 4, a data communication section 5, an image data input section 6, a positioning data input section 7, a sensor data input section 8, and a storage device 9. The functional blocks can communicate data with each other through an internal bus 10. The control section 4 is constituted by a microcomputer including a central processing unit (CPU), a read-only memory (ROM), a random-access memory (RAM), and an input/output (I/O). The microcomputer executes computer programs stored in a non-transitory tangible storage medium to perform processes corresponding to the computer programs and thus controls all operations of the on-board device 2.

The data communication section 5 controls the data communication between the on-board device 2 and the server 3. An on-board camera 11 is provided separately from the on-board device 2. The on-board camera 11 takes an image ahead of a vehicle and outputs image data that has been taken to the on-board device 2. In response to receiving the image data from the on-board camera 11, the image data input section 6 outputs the received image data to the control section 4. A global navigation satellite system (GNSS) receiver 12 is provided separately from the on-board device 2. The GNSS receiver 12 receives satellite signals transmitted from the GNSS, measures the position, and outputs the measured positioning data to the on-board device 2. In response to receiving the positioning data from the GNSS receiver 12, the positioning data input section 7 outputs the received positioning data to the control section 4. Various sensors 13 are provided separately from the on-board device 2. The sensors 13 may include, for example, a millimeter-wave radar or LiDAR (Light Detection and Ranging, Laser Imaging Detection and Ranging) and output measured sensor data to the on-board device 2. In response to receiving the sensor data from the various sensors 13, the sensor data input section 9 outputs the received sensor data to the control section 4.

The control section 4 generates probe data by associating, for example, the vehicle position, the time at which the vehicle position is measured, and the positions of landmarks, such as traffic signs or signboards above a road, and compartment lines with each other based on the image data, the positioning data, and the sensor data and stores the generated probe data in the storage device 9. It is to be noted that the probe data may include a variety of information such as the road geometry, the road characteristics, and the road width and the positional relationship.

The control section 4 reads the probe data from the storage device 9 every time (that is, every segment), for example, a predetermined time elapses or the traveling distance of the vehicle reaches a predetermined distance and transmits the probe data that has been read to the server 3 through the data communication section 5. Units of segments refer to units that partition a road or a region by predetermined units in order to manage the map. It is to be noted that the control section 4 may read the probe data in units unrelated to the units of segments and transmit the probe data that has been read to the server 3 through the data communication section 5. The units unrelated to the units of segments refer to, for example, units of regions designated by the server 3.

The server 3 includes a control section 14, a data communication section 15, and a storage device 16. The functional blocks can communicate data with each other through an internal bus 17. The control section 14 is constituted by a microcomputer including a CPU, a ROM, a RAM, and an I/O. The microcomputer executes computer programs stored in a non-transitory tangible storage medium to perform processes corresponding to the computer programs and thus controls all operations of the server 3. The computer programs executed by the microcomputer include a map processing program. The data communication section 15 controls the data communication between the server 3 and the on-board device 2. The storage device 16 includes a probe data storage section 16a, which stores probe data, an input map storage section 16b, which stores the input map before format conversion, an input map storage section 16c, which stores the input map after format conversion, an input map storage section 16d, which stores the input map after the position has been corrected, a reference map storage section 16e, which stores the reference map before format conversion, and a reference map storage section 16f, which stores the reference map after format conversion. The input map is a map generated by a later-described input map generating section 14a based on the probe data. The reference map is, for example, a map generated by measuring on site by a map supplier. That is, when the data on site is not up to date because, for example, a new road has been opened to traffic, the input map generated from the probe data includes landmarks and compartment lines, but the reference map corresponding to this site does not include the landmarks or the compartment lines.

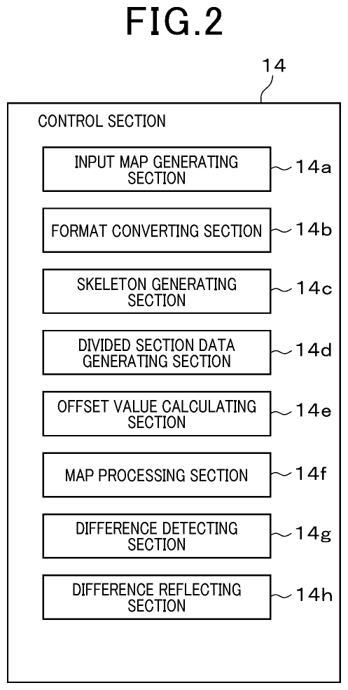

As shown in FIG. 2, the control section 14 includes an input map generating section 14a, a format converting section 14b, a skeleton generating section 14c, a divided section data generating section 14d, an offset value calculating section 14e, a map processing section 14f, a difference detecting section 14g, and a difference reflecting section 14h. The functional blocks correspond to the processes of the map processing program executed by the microcomputer.

In response to the data communication section 15 receiving the probe data transmitted from the on-board device 2, the input map generating section 14a stores the received probe data in the probe data storage section 16a. That is, since the on-board device 2 and the server 3 have a multiple-to-one relationship, the control section 14 stores multiple sets of probe data received from multiple on-board devices 2 in the probe data storage section 16a. The input map generating section 14a reads the probe data from the probe data storage section 16a and generates an input map based on the probe data that has been read.

In this case, when the probe data transmitted from the on-board device 2 is in units of segments, and the probe data is stored in the probe data storage section 16a in the units of segments, the input map generating section 14a reads the multiple sets of probe data stored in the probe data storage section 16a unchanged and generates an input map based on the probe data that has been read. When the probe data transmitted from the on-board device 2 is in units unrelated to the units of segments, and the probe data is stored in the probe data storage section 16a in the units unrelated to the units of segments, the input map generating section 14a reads the multiple sets of probe data included in the targeted segment stored in the probe data storage section 16a and generates an input map based on the probe data that has been read.

Upon generating the input map, the input map generating section 14a stores the generated input map in the input map storage section 16b. In this case, the input map generating section 14a may store one input map in the input map storage section 16b or may generate an integrated input map by integrating multiple input maps and store the integrated input map that has been generated in the input map storage section 16b.

When integrating multiple input maps, the input map generating section 14a may use probe data transmitted from different on-board devices 2 or probe data transmitted from the same on-board device 2 at different times. The input map generating section 14a desirably acquires segments including as many feature points as possible taking into consideration that there are feature points that cannot be set as the common feature points between multiple input maps. That is, the input map generating section 14a may compare the number of feature points included in the segment with a predetermined number and set one or more segments including the predetermined number or more of feature points as an acquisition target. Meanwhile, one or more segments that do not include the predetermined number or more of feature points are not set as an acquisition target. Alternatively, the input map generating section 14a may determine the detection accuracy of the feature points and set one or more segments including a predetermined number or more of feature points the detection level of which is at a predetermined level or higher as an acquisition target. Meanwhile, one or more segments that do not include the predetermined number or more of feature points the detection level of which is at the predetermined level or higher is not set as an acquisition target.

The predetermined number and the predetermined level may be fixed values or variable values determined in accordance with, for example, the traveling position or the traveling environment of a vehicle. That is, when the vehicle is traveling in an area with a relatively small number of feature points, setting the predetermined number to a large value may possibly cause the segments that can be set as the acquisition target to become too small in number, and thus the predetermined number is desirably set to a small value. In contrast, when the vehicle is traveling in an area with a relatively large number of feature points, setting the predetermined number to a small value may possibly cause the segments that can be set as the acquisition target to become too large in number, and thus the predetermined number is desirably set to a large value. The same applies to the predetermined level, and when the detection environment is under a relatively bad environment due to the influence of, for example, weather, setting the predetermined level to a high level may possibly cause the segments that can be set as the acquisition target to become too small in number, and thus the predetermined level is desirably set to a low level. In contrast, when the detection environment is under a relatively good environment, setting the predetermined level to a low level may possibly cause the segments that can be set as the acquisition target to become too large in number, and thus the predetermined level is desirably set to a high level.

The format converting section 14b reads the reference map stored in the reference map storage section 16e, converts the data format of the reference map that has been read, and stores the reference map the data format of which has been converted in the reference map storage section 16f. The format converting section 14b reads the input map stored in the input map storage section 16b, converts the data format of the input map that has been read, and stores the input map the data format of which has been converted in the input map storage section 16c. The format converting section 14b converts the data format of the reference map and the input map and makes the data formats of the reference map and the input map the same.

The skeleton generating section 14c generates a skeleton that represents the road geometry based on the input map. The skeleton generating section 14c uses any of first to third methods below as the method for generating a skeleton. The first method generates a skeleton based on the set of probe data with the largest number of data points per unit length among the multiple sets of probe data corresponding to the compartment lines. The second method generates a skeleton based on the set of probe data closest to a road center line among the multiple sets of probe data corresponding to the compartment lines. The third method generates a skeleton based on a reference line used when the integrated input map is generated by integrating multiple input maps.

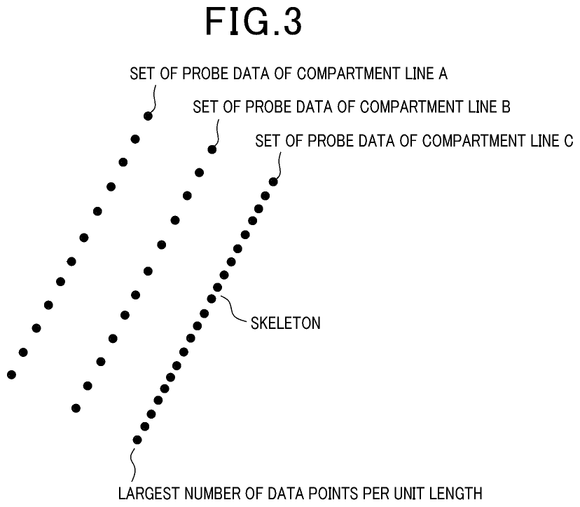

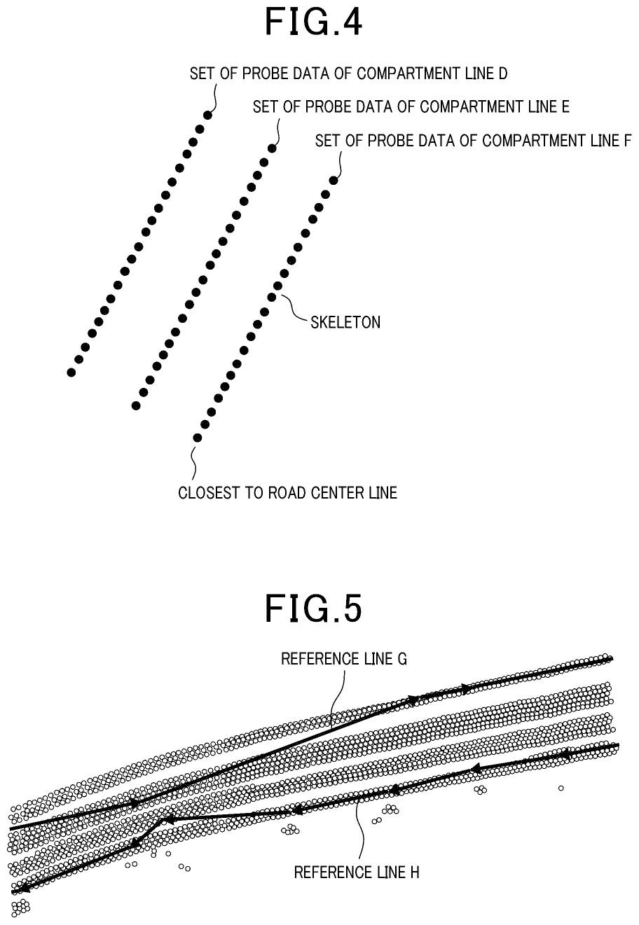

More specifically, in the case in which the first method is used, as shown in FIG. 3, the skeleton generating section 14c generates a skeleton based on the set of probe data with the largest number of data points per unit length among the multiple sets of probe data on condition that the difference between the number of data points among the multiple sets of probe data corresponding to the compartment lines A to C is greater than or equal to a threshold value. In the example of FIG. 3, the skeleton generating section 14c generates a skeleton based on the set of probe data of the compartment line C among the sets of probe data of the compartment lines A to C. In the case in which the second method is used, as shown in FIG. 4, the skeleton generating section 14c generates a skeleton based on the set of probe data closest to the road center line among the multiple sets of probe data on condition that the difference between the number of data points among the multiple sets of probe data corresponding to the compartment lines A to C is less than the threshold value. In the example of FIG. 4, the skeleton generating section 14c generates a skeleton based on the set of probe data of a compartment line F among the sets of probe data of compartment lines D to F. In the case in which the third method is used, as shown in FIG. 5, the skeleton generating section 14c generates a skeleton based on the reference line used when the integrated input map is generated by integrating multiple input maps. In the example of FIG. 5, the skeleton generating section 14c generates a skeleton based on reference lines G and H used when the integrated input map is generated.

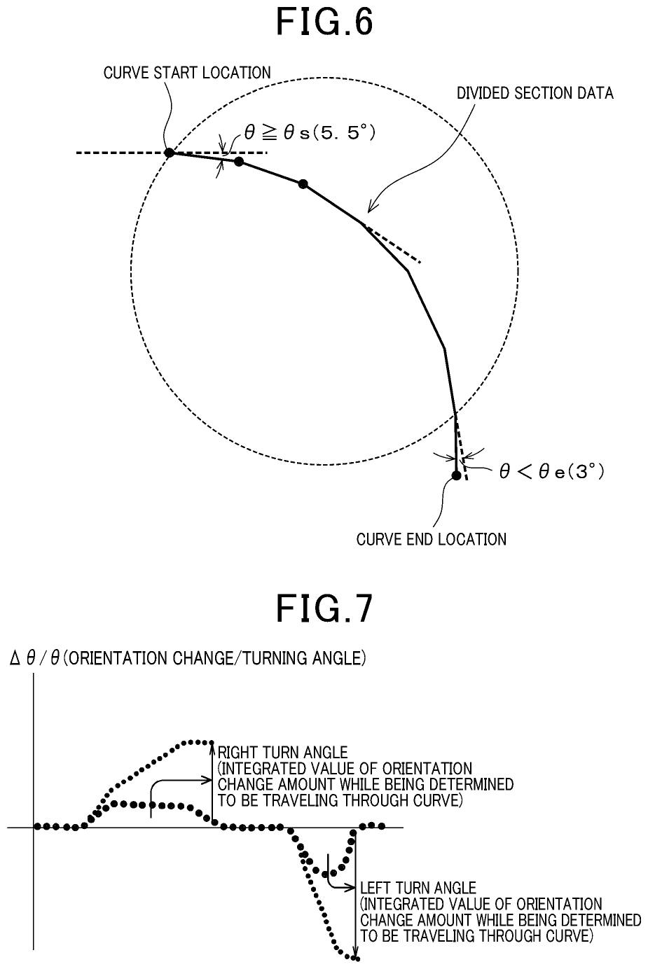

In response to the skeleton generating section 14c generating the skeleton, the divided section data generating section 14d generates divided section data by dividing the generated skeleton at division points. As shown in FIG. 6, the divided section data generating section 14d previously sets a curve start angle (θs) and a curve end angle (θe). The location at which the orientation change amount becomes greater than or equal to the curve start angle is set as a curve start location, and the location at which the orientation change amount becomes less than the curve end angle is set as a curve end location. The curve start angle is, for example, 5.5 degrees, and the curve end angle is, for example, 3 degrees. The divided section data generating section 14d sets, as the division points, the curve start location and the curve end location that have been set and generates divided section data of the section between the division points that have been set. In this case, as shown in FIG. 7, the divided section data generating section 14d calculates, as a turning angle, an accumulated value of the orientation change amount from when the orientation change amount becomes greater than or equal to the curve start angle until when the orientation change amount becomes less than the curve end angle.

In response to the divided section data generating section 14d generating the divided section data, the offset value calculating section 14e calculates an offset value between the input map and the reference map per section corresponding to the divided section data that has been generated.

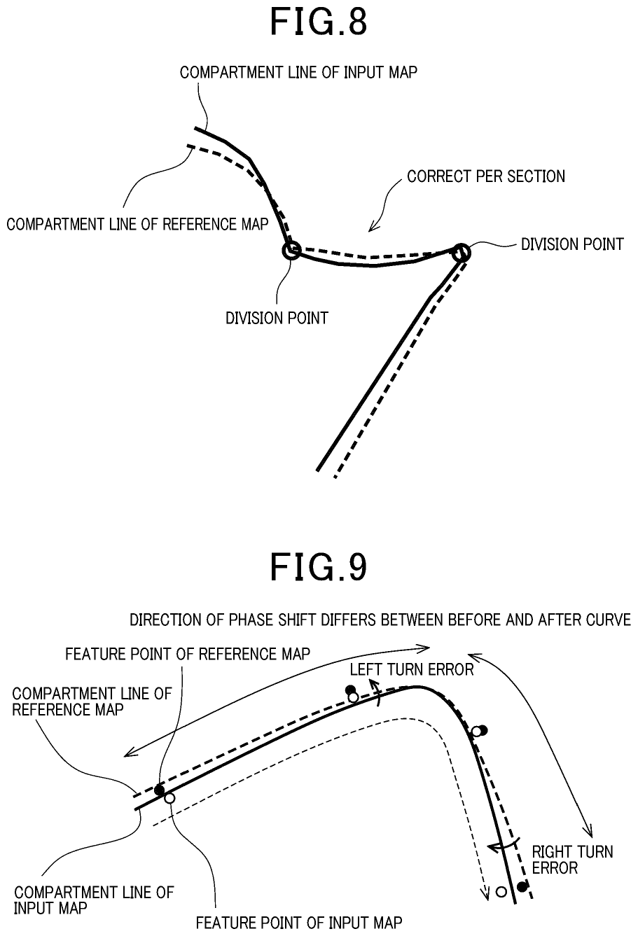

In response to the offset value calculating section 14e calculating the offset value, the map processing section 14f corrects the position of the input map based on the reference map using the calculated offset value. That is, the map processing section 14f corrects the position of the input map by superimposing the reference map on the input map so that the feature points included in the reference map coincide with the feature points included in the input map. As shown in FIG. 8, the map processing section 14f corrects the position of the input map based on the reference map using the offset value of each section corresponding to the divided section data.

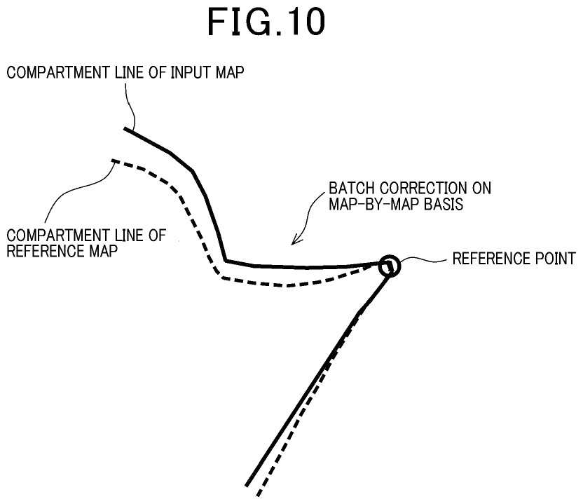

Since the direction of the phase shift differs between before and after the curve as shown in FIG. 9, with the conventional structure in which batch correction is performed on a map-by-map basis, the displacement between the maps is caused differently in different parts instead of uniformly over a wide area as shown in FIG. 10. Thus, although the displacement between the maps is relatively small in the region close to the reference point, which is set as the reference, the displacement between the maps is relatively large in the region separate from the reference point, which hinders eliminating the displacement between the maps over a wide area. In contrast, in the present embodiment, the map processing section 14f generates the divided section data and makes corrections per section corresponding to the divided section data that has been generated. This obviates the occurrence of displacement between maps differently in different parts and appropriately eliminates the displacement between maps over a wide area.

In response to determining that the positions of at least four feature points coincide between the reference map and the input map by correcting the position of the input map based on the reference map, the difference detecting section 14g determines that the position of the input map has been successfully corrected and detects the difference between the reference map and the input map. In this case, the difference detecting section 14g detects static information and dynamic information in the reference map as the difference. The static information includes, for example, feature point information about the feature points, compartment line information about the compartment lines, and position information about locations. The feature point information includes, for example, position coordinates showing the position of the feature point, identifier (ID) that identifies the feature point, feature point size, feature point shape, feature point color, and feature point type. The compartment line information includes, for example, position coordinates showing the position of the compartment line, identifier (ID) that identifies the compartment line, and types such as a broken line and a solid line. The position information about locations includes, for example, GPS coordinates showing the location on a road. The dynamic information includes vehicle information about a vehicle on a road such as a vehicle speed value, blinker operation information, lane straddling, a steering angle value, a yaw rate value, and GPS coordinates. In response to the difference detecting section 14g detecting the difference between the reference map and the input map, the difference reflecting section 14h reflects the detected difference in the reference map to update the reference map.

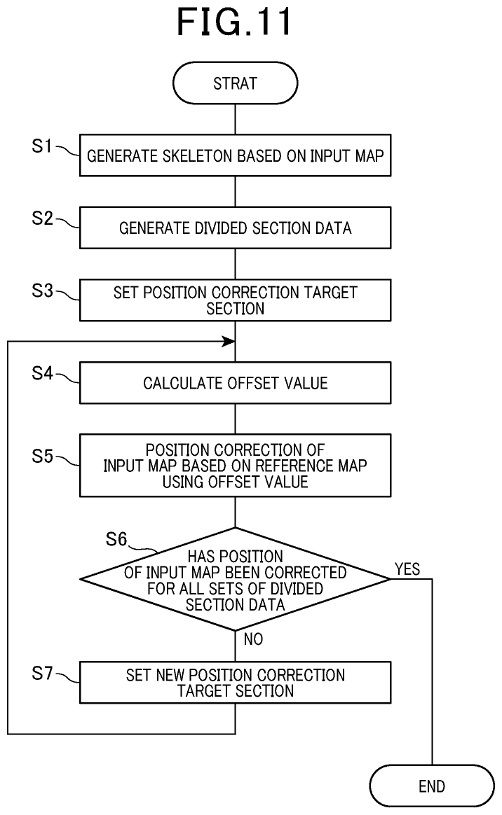

Next, the operation of the above-described configuration will be described with reference to FIG. 11.

Upon starting the process of correcting the position of the input map, the control section 14 of the server 3 generates a skeleton representing the road geometry based on the input map (S1, corresponds to a skeleton generating step). Upon generating the skeleton, the control section 14 divides the generated skeleton at the division points to generate the divided section data (S2, corresponds to a divided section data generating step). The control section 14 sets any divided section data as a position correction target section (S3) and calculates an offset value between the input map and the reference map for the divided section data set as the position correction target section (S4, corresponds to an offset value calculating step). Upon calculating the offset value, the control section 14 corrects the position of the input map based on the reference map using the calculated offset value (S5).

The control section 14 determines whether the position of the input map has been corrected in all sets of the divided section data based on the reference map (S6), and upon determining that the position of the input map has not been corrected in all the sets of divided section data based on the reference map (S6: NO), the control section 14 sets a new position correction target section (S7), returns to step S4, and repeats step S4 and the following steps. Upon determining that the position of the input map has been corrected in all the sets of divided section data based on the reference map (S6: YES), the control section 14 terminates the process of correcting the position of the input map.

According to the present embodiment as described above, the following operational advantages are achieved.

The server 3 generates the skeleton representing the road geometry based on the input map, generates the divided section data by dividing the generated skeleton at the division points, and calculates the offset value between the input map and the reference map per section corresponding to the divided section data that has been generated. When the offset value is calculated, the position of the input map is corrected based on the calculated offset value. The offset value is calculated per section corresponding to the divided section data, and the correction is made per section. Thus, the displacement between the maps is appropriately eliminated over a wide area, and the position of the input map is corrected appropriately.

The server 3 generates the skeleton of the set of probe data with the largest number of data points per unit length among the multiple sets of probe data corresponding to the compartment line. The skeleton can be generated by determining the set of probe data with the largest number of data points per unit length.

The server 3 generates the skeleton of the set of probe data closest to the road center line among the multiple sets of probe data corresponding to the compartment lines. The skeleton can be generated by determining the set of probe data closest to the road center line.

The server 3 generates the skeleton of the reference line used when the integrated input map is generated by integrating multiple input maps. The skeleton can be generated by determining the reference line used when the integrated input map is generated.

Although the present disclosure has been described in accordance with the embodiments, it is understood that the present disclosure is not limited to the embodiments and the configurations thereof. The present disclosure embraces various modifications and deformations that come within the range of equivalency. Additionally, various combinations and forms, or other combinations and forms including only one or more additional elements, or less than all elements are included in the scope and ideas obtainable from the present disclosure.

The control section and the method disclosed in the present disclosure may be achieved by a dedicated computer constituted by a processor and a memory, which are programmed to execute one or more functions embodied by computer programs. Alternatively, the control section and the method disclosed in the present disclosure may be achieved by a dedicated computer provided by configuring a processor with one or more dedicated hardware logic circuits. Alternatively, the control section and the method disclosed in the present disclosure may be achieved by one or more dedicated computers constituted by a combination of a processor and a memory, which are programmed to execute one or more functions, and a processor constituted by one or more hardware logic circuits. Additionally, the computer program may be stored in a non-transitory, tangible computer-readable storage medium as instructions to be executed by a computer.

The server 3 has been illustrated that does not set, as the acquisition target, the segments that do not include the predetermined number or more of feature points and the segments that do not include the predetermined number or more of feature points the detection level of which is at the predetermined level or higher. However, conditions may be set for the on-board device 2 to transmit the probe data including the segments to the server 3. That is, the on-board device 2 has been illustrated that transmits the probe data to the server 3 every time, for example, the predetermined time elapses or the traveling distance of the vehicle reaches the predetermined distance. However, the on-board device 2 may determine the number of detected feature points included in the segment and transmit the probe data to the server 3 only when the number of detected feature points is greater than or equal to a predetermined number. That is, since there are cases in which the number of detected feature points is not greater than or equal to the predetermined number due to, for example, the existence of a preceding vehicle, the on-board device 2 may be configured not to transmit the probe data to the server 3 when it is assumed that even if the probe data including the segment with less than the predetermined number of detected feature points is transmitted to the server 3, the server 3 will not process the probe data and will discard the probe data. Not transmitting unnecessary probe data to the server 3 from the on-board device 2 can reduce the load on the data communication.

What is claimed is:

1. A map processing system comprising:
a skeleton generating section configured to generate a skeleton that represents a road geometry based on a first map;
a divided section data generating section configured to generate divided section data by dividing the skeleton at a division point;
an offset value calculating section configured to calculate an offset value between the first map and a second map per section corresponding to the divided section data; and
a map processing section configured to process the first map using the offset value.

2. The map processing system according to claim 1, wherein
the skeleton generating section is configured to generate the skeleton of a set of probe data with a largest number of data points per unit length among a plurality of sets of probe data corresponding to compartment lines.

3. The map processing system according to claim 1, wherein
the skeleton generating section is configured to generate the skeleton of a set of probe data closest to a road center line among a plurality of sets of probe data corresponding to compartment lines.

4. The map processing system according to claim 1, wherein
the skeleton generating section is configured to generate the skeleton of a reference line used when an integrated input map is generated by integrating a plurality of input maps.

5. The map processing system according to claim 1, wherein
the map processing section is configured to use a first input map as the first map and a second input map as the second map and generate an integrated input map by integrating the first input map and the second input map.

6. The map processing system according to claim 1, wherein
the map processing section is configured to use an input map as the first map and a reference map as the second map and correct the position of the input map based on the reference map.

7. A non-transitory computer-readable storage medium containing thereon a program comprising instructions configured to cause one or more processors of a map processing device to execute a map process, the instructions comprising:
generating a skeleton that represents a road geometry based on a first map;
generating divided section data by dividing the skeleton at a division point;
calculating an offset value between the first map and a second map per section corresponding to the divided section data; and
processing the first map using the offset value.
